(19) United States
(12) Patent Application Publication
(10) Pub. No.: US 2022/0214703 A1
(43) Pub. Date: Jul. 7, 2022

(54) FLIGHT METHOD AND APPARATUS FOR UNMANNED AERIAL VEHICLE AND UNMANNED AERIAL VEHICLE

(71) Applicant: AUTEL ROBOTICS CO., LTD, Shenzhen (CN)

(72) Inventor: Ziming ZHONG, Shenzhen (CN)

(21) Appl. No.: 17/656,374

(22) Filed: Mar. 24, 2022

Related U.S. Application Data
(63) Continuation of application No. PCT/CN2020/115969, filed on Sep. 17, 2020.

(30) Foreign Application Priority Data
Sep. 26, 2019 (CN) 201910917052.8

(51) Int. Cl. G05D 1/10; G05D 1/00; G05D 13/66; B64C 39/02

(52) U.S. Cl. CPC G05D 1/106; G05D 1/0055; B64C 2201/141; B64C 39/024; G05D 13/66

(57) ABSTRACT

Embodiments of the disclosure relate to a flight method and apparatus for an unmanned aerial vehicle (UAV) and a UAV. The method includes: obtaining a distance between the UAV and an electronic fence; applying a virtual resistance force to the UAV if the distance is less than a preset distance threshold value; and obtaining a speed instruction according to the virtual resistance force, to adjust a flight speed of the UAV according to the speed instruction. In the embodiments of the disclosure, when a distance between a UAV and an electronic fence is less than a preset distance threshold value, a virtual resistance force is applied to the UAV, and a speed instruction is obtained according to the virtual resistance force, to adjust a flight speed of the UAV. By means of the embodiments of the disclosure, the acceleration of a UAV can be reduced. In this way, a distance by which the UAV rushes into a restricted area is reduced.

### CROSS REFERENCE

The present application is a continuation of International Application No. PCT/CN2020/115969, filed on Sep. 17, 2020, which claims priority to Chinese patent application No. 2019109170528, filed on Sep. 26, 2019, which is incorporated herein by reference in its entirety.

### TECHNICAL FIELD

Embodiments of the disclosure relate to the field of unmanned aircraft technologies, and in particular, to a flight method and apparatus for an unmanned aerial vehicle (UAV) and a UAV.

### BACKGROUND

With the development of UAV technologies, UAVs have been widely used in both military and civilian fields, especially the rise of consumer UAVs leads to a growing problem of airspace safety. Therefore, to ensure orderly and safe flight in airspace, there are strict restrictions on flight of civilian unmanned aircrafts in certain sensitive areas (such as airports), such as a height restriction, a flight restriction and a no-fly restriction.

At present, restrictions on unmanned aircrafts in sensitive areas are usually implemented by means of an electronic fence technology. A virtual electronic fence is built in the form of a software program on a map of an unmanned aircraft, to hinder or restrict actual flight of the unmanned aircraft in an area of the electronic fence. The electronic fence is a boundary between a normal flight area and a restricted area. The foregoing software program needs to ensure that the unmanned aircraft flies normally and responds to flight instructions in the normal flight area, and limits a height, hovers or even makes a forced landing according to corresponding restriction rules in the restricted area.

During implementation of the disclosure, the inventor finds that the foregoing method has at least the following problems: when the unmanned aircraft approaches the restricted area from the normal flight area, the speed of the unmanned aircraft needs to be promptly reduced, but due to inertia, the unmanned aircraft inevitably crosses the electronic fence and rushes into the restricted area.

### SUMMARY

An objective of embodiments of the disclosure is to provide a flight method and apparatus for a UAV and a UAV, which can reduce a distance by which a UAV crosses an electronic fence and rushes into a restricted area.

According to a first aspect, an embodiment of the disclosure provides a flight method for a UAV, applicable to a UAV, where the method includes:

obtaining a distance between the UAV and an electronic fence;

applying a virtual resistance force to the UAV if the distance is less than a preset distance threshold value, to reduce a speed of the UAV; and

obtaining a speed instruction according to the virtual resistance force, to adjust a flight speed of the UAV according to the speed instruction.

In some embodiments, the virtual resistance force is obtained by using a virtual impedance model.

In some embodiments, the obtaining a speed instruction according to the virtual resistance force includes:

performing vector composition on the virtual resistance force and a force applied to the UAV to obtain a resultant force;

obtaining a desired acceleration of the UAV according to the resultant force; and

obtaining the speed instruction according to the desired acceleration.

In some embodiments, the method further includes:

unloading the virtual resistance force when the distance is greater than the preset distance threshold value.

In some embodiments, the virtual impedance model includes at least any of a virtual spring, a virtual damping and a virtual mass.

According to a second aspect, an embodiment of the disclosure provides a flight apparatus for a UAV, applicable to a UAV, where the apparatus includes:

a distance obtaining module, configured to obtain a distance between the UAV and an electronic fence;

a virtual resistance force application module, configured to apply a virtual resistance force to the UAV when the distance is less than a preset distance threshold value; and

a speed instruction obtaining module, configured to obtain a speed instruction according to the virtual resistance force, to adjust a flight speed of the UAV according to the speed instruction.

In some embodiments, the virtual resistance force is obtained by using a virtual impedance model.

In some embodiments, the speed instruction obtaining module is further configured to: perform vector composition on the virtual resistance force and a force applied to the UAV to obtain a resultant force;

obtain a desired acceleration of the UAV according to the resultant force; and

obtain the speed instruction according to the desired acceleration.

In some embodiments, the apparatus further includes:

a virtual resistance force unloading module, configured to unload the virtual resistance force when the distance is greater than the preset distance threshold value.

In some embodiments, the virtual impedance model includes at least any of a virtual spring, a virtual damping and a virtual mass.

According to a third aspect, an embodiment of the disclosure provides a UAV, including: a vehicle body, an arm connected to the vehicle body, a power system disposed in the arm and a flight controller disposed in the vehicle body, where the flight controller includes:

at least one processor; and

a memory communicatively connected to the at least one processor, where

the memory stores instructions capable of being executed by the at least one processor, and the instructions are executed by the at least one processor, to enable the at least one processor to perform the foregoing method.

According to a fourth aspect, an embodiment of the disclosure provides a non-volatile computer-readable storage medium, storing computer-executable instructions, the computer-executable instructions, when being executed by a UAV, causing the UAV to perform the foregoing method.

According to a fifth aspect, an embodiment of the present application further provides a computer program product including a computer program stored in a non-volatile computer-readable storage medium, the computer program including program instructions, and the program instructions, when being executed by a UAV, causing the UAV to perform the foregoing method.

In the flight method and apparatus for a UAV and the UAV according to the embodiments of the disclosure, when a distance between a UAV and an electronic fence is less than a preset distance threshold value, a virtual resistance force is applied to the UAV, and a speed instruction is obtained according to the virtual resistance force, to adjust a flight speed of the UAV. According to the embodiments of the disclosure, the speed of a UAV can be reduced. In this way, a distance by which the UAV rushes into a restricted area is reduced, so as to make the UAV return to a normal flight area outside the electronic fence as soon as possible.

### BRIEF DESCRIPTION OF THE DRAWINGS

One or more embodiments are exemplarily described with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic diagram of an application scenario of a flight method and apparatus for a UAV according to an embodiment of the disclosure.

FIG. 2 is a schematic structural diagram of an embodiment of a UAV according to the disclosure.

FIG. 3 is a schematic flowchart of an embodiment of a flight method for a UAV according to the disclosure.

FIG. 4 is a schematic diagram of a virtual impedance model in an embodiment of a flight method for a UAV according to the disclosure.

FIG. 5 is a schematic structural diagram of an embodiment of a flight apparatus for a UAV according to the disclosure.

FIG. 6 is a schematic structural diagram of an embodiment of a flight apparatus for a UAV according to the disclosure.

FIG. 7 is a schematic structural diagram of the hardware structure of a flight controller in an embodiment of a UAV according to the disclosure.

### DETAILED DESCRIPTION

To make the objectives, technical solutions, and advantages of the embodiments of the present invention clearer, the following clearly and completely describes the technical solutions in the embodiments of the present invention with reference to the accompanying drawings in the embodiments of the present invention. Apparently, the described embodiments are merely some embodiments of the present invention rather than all of the embodiments. All other embodiments obtained by a person of ordinary skill in the art based on the embodiments of the present application without creative efforts shall fall within the protection scope of the present application.

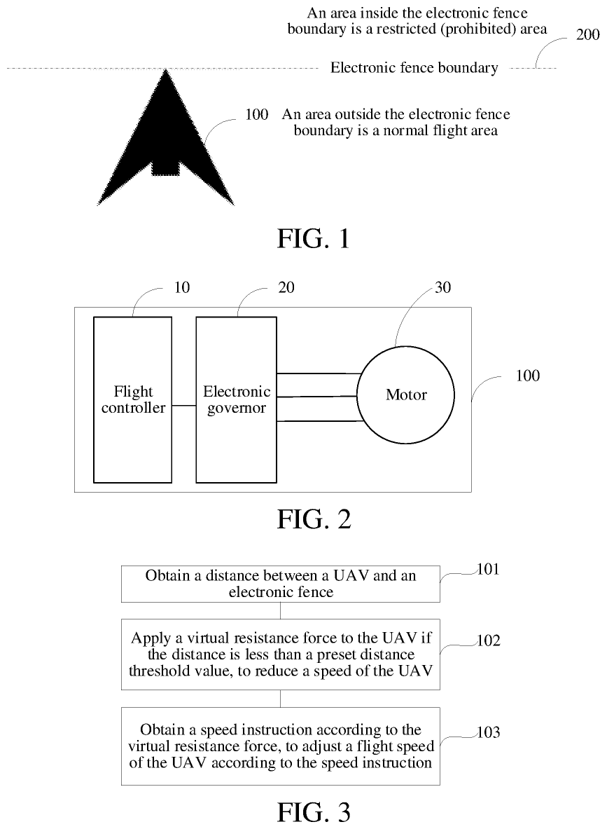

A flight method and apparatus for a UAV provided in embodiments of the disclosure are applicable to an application scenario shown in FIG. 1. In the application scenario shown in FIG. 1, a UAV 100 and an electronic fence 200 are included. The UAV 100 may be a suitable unmanned aircraft, including a fixed-wing unmanned aircraft and a rotary-wing unmanned aircraft, such as a helicopter, a quadcopter, and an aircraft with other quantities of rotors and/or rotor configurations. The UAV 100 may be alternatively another movable object such as a manned aerial vehicle, a model airplane, an unmanned airship, or an unmanned hot air balloon. The electronic fence 200 is a virtual fence built in the form of a software program on a flight map of a UAV. The electronic fence is used for defining a normal flight area and a restricted area. In the normal flight area, the UAV can fly normally and respond to flight instructions. In the restricted area, the UAV needs to limit a height, hover or even make a forced landing according to corresponding restriction rules.

In some embodiments, referring to FIG. 2, the UAV 100 includes a vehicle body, an arm connected to the vehicle body, a power system disposed in the arm and a control system disposed in the vehicle body 10 (none of the vehicle body, the arm, the power system and the control system is shown in the figure). The power system is configured to provide thrust, lift, and the like to the UAV 100 for flight. The power system includes an electronic governor 20, a motor 30 and blades (not shown). The control system includes a flight controller 10, configured to send a throttle control signal (for example, a speed instruction) and other control signals to the electronic governor 20. The electronic governor 20 is configured to adjust a rotational speed of the motor 30 according to the control signal sent by the flight controller 10. The motor 30 is configured to drive the blades of the UAV 100 to rotate to supply power to the UAV 100 for flight.

When approaching an electronic fence boundary and flying from the normal flight area toward the restricted area, the UAV 100 tends to break cross the electronic fence boundary and rush into the restricted area due to inertia. To reduce a distance by which the UAV 100 rushes into the restricted area, in an embodiment of the disclosure, when the UAV 100 approaches the electronic fence boundary, a virtual resistance force is applied to the UAV 100. Then, a speed instruction is obtained according to the virtual resistance force, and a flight speed of the UAV is adjusted according to the speed instruction. According to the embodiment of the disclosure, the flight speed of the UAV 100 can be reduced. In this way, the distance by which the UAV rushes into the restricted area is reduced.

It should be noted that, the applying a virtual resistance force to the UAV in the embodiment of the disclosure does not mean that an actual force is applied to the UAV, but means that the virtual resistance force is introduced into a control strategy of the UAV to obtain a desired speed after the introduction of the virtual resistance force, that is, the speed instruction, and then the flight speed of the UAV is adjusted according to the speed instruction, to implement overall and smooth deceleration.

FIG. 3 is a schematic flowchart of a flight method for a UAV provided in the embodiment of the disclosure. The method may be performed by a UAV (for example, the UAV 100 in FIG. 1, and in particular, in some embodiments, the method is performed by the flight controller in the UAV 100). As shown in FIG. 3, the method includes the following steps.

101: Obtain a distance between the UAV and an electronic fence.

Specifically, in some embodiments, the UAV obtains a position of the UAV and positions of boundary points of an electronic fence boundary in real time, and obtains a minimum distance from distances between the UAV and the boundary points. The minimum distance is the distance between the UAV and the electronic fence.

102: Apply a virtual resistance force to the UAV if the distance is less than a preset distance threshold value.

If the distance between the UAV and the electronic fence is less than the preset distance threshold value, it indicates that the UAV is close to the electronic fence boundary. To reduce the distance by which the UAV rushes into the restricted area, a virtual resistance force is applied to the UAV in this case. The virtual resistance force is not actually applied to the UAV, but is introduced into the control strategy of the UAV to adjust the flight of the UAV.

In some embodiments, the virtual resistance force may be obtained by using a virtual impedance model. The virtual impedance model may include at least any of a virtual spring, a virtual damping and a virtual mass. That is, the virtual impedance model includes one or more of a virtual spring, a virtual damping and a virtual mass. For example, the virtual impedance model includes a virtual spring and a virtual mass, or includes a virtual spring, a virtual damping and a virtual mass.

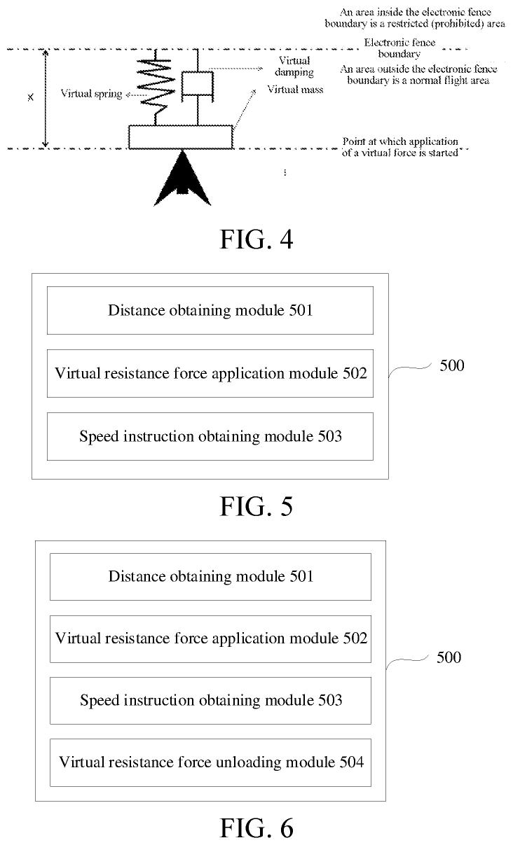

FIG. 4 shows a virtual impedance model including a virtual spring, a virtual damping and a virtual mass. The virtual spring, virtual damping and virtual mass may be connected in series or connected in parallel. The virtual resistance force may be obtained based on virtual elements of the impedance model and a connection relationship between the virtual elements.

An embodiment shown in FIG. 4 is used as an example. The virtual resistance force F_{resistance} can be obtained by the following formula:

$${F}_{resistance} = M \ddot{X} + C \dot{X} + KX ,$$

where X is a displacement of the UAV from a point at which application of a virtual force is started to the electronic fence boundary, M is a mass of the virtual mass, K is a stiffness coefficient of the virtual spring, and C is a damping coefficient of the virtual damping. Parameters of M, K and C can be appropriately selected as required for boundary flight restriction response. For example, these parameters are set according to a requirement of a maximum distance by which the UAV rushes into the restricted area or a settling time requirement.

The preset distance threshold value may be set according to actual applications, for example, may be set to 100 meters, 50 meters, 30 meters, or the like.

A UAV is subjected to various forces during flight, such as thrust, lift, and gravity. These forces act together to affect an acceleration of the UAV, which in turn affects the flight speed of the UAV. In the embodiment of the disclosure, a virtual resistance force is applied to the UAV. That is, it is assumed that the UAV is also subjected to a virtual resistance force. The virtual resistance force has an effect of reducing the acceleration of the UAV, thereby reducing the speed of the UAV. A direction of the virtual resistance force may be opposite to a direction of the flight speed of the UAV.

103: Obtain a speed instruction according to the virtual resistance force, to adjust a flight speed of the UAV according to the speed instruction.

In some embodiments of the disclosure, the virtual resistance force may be introduced into composition of forces. A desired acceleration is calculated through a resultant force in which the virtual resistance force is introduced, then a desired speed is calculated, and the flight speed of the UAV is adjusted according to the desired speed, to implement a reduction of speed. Specifically, vector composition is first performed on the virtual resistance force and other forces applied to the UAV, to obtain a resultant force, and then a desired acceleration a is obtained according to the kinetic equation F=ma, and a desired speed, that is, the speed instruction, is obtained according to the desired acceleration a.

The motion of the UAV within a short period of time may be considered as uniformly accelerated linear motion with a constant acceleration. Therefore, in some embodiments, the desired speed is calculated at short intervals Δt. In the uniformly accelerated linear motion, v1=v0+aΔt is satisfied, where v1 is a speed (that is, the desired speed) after Δt, v0 is an initial speed, which can be measured by using a speed sensor of the UAV (for example, an ultrasonic speed sensor or a pitot tube). Because a and Δt are known, the desired speed v1 can be calculated by the foregoing formula. In this way, the desired speed (that is, the speed instruction) is obtained every Δt, and after the speed instruction is obtained, the flight controller sends the speed instruction to the electronic governor. Therefore, the electronic governor can adjust the rotational speed of the motor according to the speed instruction, to adjust the flight speed of the UAV.

After the virtual resistance force is applied to the UAV, the speed of the UAV continuously decreases. When the speed decreases to zero, the UAV may be at a safe distance, or may still be in the restricted area or at a position at which the distance between the UAV and the electronic fence is less than the preset distance threshold value. Therefore, in some embodiments of the disclosure, the virtual resistance force is not unloaded when the speed of the UAV decreases to zero. Under the action of the virtual resistance force, the UAV flies toward the normal flight area, that is, returns to the safe distance. When the distance between the UAV and the electronic fence boundary is greater than the preset distance threshold value, the virtual resistance force is unloaded. According to the embodiment of the disclosure, it can be ensured that the UAV returns to the safe distance, thereby further improving flight safety.

In the embodiment of the disclosure, when a distance between a UAV and an electronic fence is less than a preset distance threshold value, a virtual resistance force is applied to the UAV, and a speed instruction is obtained according to the virtual resistance force, to adjust a flight speed of the UAV. According to the embodiment of the disclosure, a flight speed of a UAV can be reduced. In this way, a distance by which the UAV rushes into a restricted area is reduced. In addition, according to the embodiment of the disclosure, a speed limit instruction received by the UAV near the electronic fence boundary can be made smoother, and an abrupt change instruction can be avoided. This makes boundary flight of the UAV smoother.

Correspondingly, as shown in FIG. 5, an embodiment of the disclosure further provides a flight apparatus for a UAV applicable to a UAV (for example, the UAV shown in FIG. 1). The flight apparatus 500 for a UAV includes:

a distance obtaining module 501, configured to obtain a distance between the UAV and an electronic fence;

a virtual resistance force application module 502, configured to apply a virtual resistance force to the UAV if the distance is less than a preset distance threshold value;

a speed instruction obtaining module 503, configured to obtain a speed instruction according to the virtual resistance force, to adjust a flight speed of the UAV according to the speed instruction.

In the embodiment of the disclosure, when a distance between a UAV and an electronic fence is less than a preset distance threshold value, a virtual resistance force is applied to the UAV, and a speed instruction is obtained according to the virtual resistance force, to adjust a flight speed of the UAV. According to the embodiment of the disclosure, a flight speed of a UAV can be reduced. In this way, a distance by which the UAV rushes into a restricted area is reduced. In addition, according to the embodiment of the disclosure, a speed limit instruction received by the UAV near the electronic fence boundary can be made smoother, and an abrupt change instruction can be avoided. This makes boundary flight of the UAV smoother.

In some embodiments, the virtual resistance force is obtained by using a virtual impedance model.

In some embodiments, the speed instruction obtaining module 503 is further configured to:

perform vector composition on the virtual resistance force and a force applied to the UAV to obtain a resultant force;

obtain a desired acceleration of the UAV according to the resultant force; and

obtain the speed instruction according to the desired acceleration.

In some embodiments, as shown in FIG. 6, the apparatus further includes:

a virtual resistance force unloading module 504, configured to unload the virtual resistance force when the distance is greater than the preset distance threshold value.

In some embodiments, the virtual impedance model includes at least any of a virtual spring, a virtual damping and a virtual mass.

It should be noted that, the foregoing apparatus may perform the method provided in the embodiments of the present application, and has the corresponding functional modules for performing the method and beneficial effects thereof. For technical details not described in detail in the apparatus embodiment, reference may be to the method provided in the embodiments of the present application.

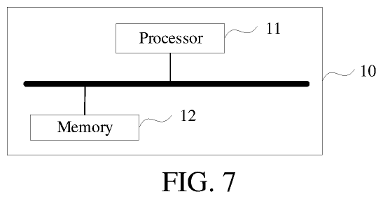

FIG. 7 is a schematic structural diagram of the hardware structure of the flight controller 10 in an embodiment of a UAV according to the disclosure. As shown in FIG. 7, the flight controller 10 includes:

one or more processors 11 and a memory 12. One processor 11 is used as an example in FIG. 7.

The processor 11 and the memory 12 may be connected by a bus or in another manner and are, for example, connected by a bus in FIG. 7.

The memory 12, as a non-volatile computer-readable storage medium, may be configured to store a non-volatile software program, a non-volatile computer-executable program and a module, such as program instructions/modules (for example, the distance obtaining module 501, the virtual resistance force application module 502 and the speed instruction obtaining module 503 shown in FIG. 5) corresponding to the flight method for a UAV in the embodiment of the present application. The processor 11 runs the non-volatile software program, the instruction and the module stored in the memory 12, to implement various functional applications and data processing of the flight controller, that is, to implement the flight method for a UAV in the foregoing method embodiments.

The memory 12 may include a program storage area and a data storage area. The program storage area may store an operating system, an application program required by at least one function and the like. The data storage area may store data created according to use of the image sending terminal or the like. In addition, the memory 12 may include a high speed random access memory, and may also include a non-volatile memory, such as at least one magnetic disk storage device, a flash memory, or another volatile solid-state storage device. In some examples, the memory 12 optionally includes memories disposed remote to the processor 11, and these memories may be connected to the flight controller by a network. Examples of the network include, but are not limited to, the Internet, an intranet, a local area network, a mobile communication network, and a combination thereof.

The one or more modules are stored in the memory 12, and when executed by the one or more processors 11, perform the flight method for a UAV in any method embodiment, for example, perform steps 101 to 103 of the foregoing method in FIG. 3; and implement the functions of the modules 501 to 503 in FIG. 5 and the modules 501 to 504 in FIG. 6.

The foregoing product may perform the method provided in the embodiments of the present application, and have the corresponding functional modules for performing the method and beneficial effects thereof. For technical details not described in detail in this embodiment, reference may be made to the method provided in the embodiments of the present application.

An embodiment of the present application provides a non-volatile computer-readable storage medium storing computer-executable instructions. The computer-executable instructions are executed by one or more processors, for example, the processor 11 in FIG. 7, to enable the one or more processors to perform the flight method for a UAV in any method embodiment, for example, to perform steps 101 to 103 of the foregoing method in FIG. 3; and to implement the functions of the modules 501 to 503 in FIG. 5 and the modules 501 to 504 in FIG. 6.

The foregoing described device embodiments are merely examples. The units described as separate parts may or may not be physically separate, and the parts displayed as units may or may not be physical units, may be located in one position, or may be distributed on a plurality of network units. Some or all of the modules may be selected according to actual needs to achieve the objectives of the solutions of the embodiments.

Through the description of the foregoing embodiments, a person skilled in the art may clearly understand that the embodiments may be implemented by software in combination with a universal hardware platform, and may certainly be implemented by hardware. A person of ordinary skill in the art may understand that, all or some of the processes of the method in the foregoing embodiments may be implemented by a computer program instructing relevant hardware. The program may be stored in a computer-readable storage medium. During execution of the program, the processes of the foregoing method embodiments may be included. The foregoing storage medium may be a magnetic disk, an optical disc, a read-only memory (ROM), a random access memory (RAM), or the like.

Finally, it should be noted that the foregoing embodiments are merely used for describing the technical solutions of the disclosure, but are not intended to limit the disclosure. Under the concept of the disclosure, the technical features in the foregoing embodiments or different embodiments may be combined, the steps may be implemented in any sequence, and there may be many other changes in different aspects of the disclosure as described above. For brevity, those are not provided in detail. Although the disclosure is described in detail with reference to the foregoing embodiments, a person of ordinary skill in the art should understand that they may still make modifications to the technical solutions described in the foregoing embodiments or make equivalent replacements to some technical features thereof, without departing from the scope of the technical solutions of the embodiments of the disclosure.

What is claimed is:

1. A flight method for an unmanned aerial vehicle (UAV), applicable to a UAV, the method comprising:
obtaining a distance between the UAV and an electronic fence;
applying a virtual resistance force to the UAV if the distance is less than a preset distance threshold value; and
obtaining a speed instruction according to the virtual resistance force, to adjust a flight speed of the UAV according to the speed instruction.

2. The method according to claim 1, wherein the virtual resistance force is obtained by using a virtual impedance model.

3. The method according to claim 1, wherein the obtaining a speed instruction according to the virtual resistance force comprises:
performing vector composition on the virtual resistance force and a force applied to the UAV to obtain a resultant force;
obtaining a desired acceleration of the UAV according to the resultant force; and
obtaining the speed instruction according to the desired acceleration.

4. The method according to claim 1, wherein the method further comprises:
unloading the virtual resistance force when the distance is greater than the preset distance threshold value.

5. The method according to claim 2, wherein the virtual impedance model comprises at least any of a virtual spring, a virtual damping and a virtual mass.

6. A flight apparatus for a UAV, applicable to a UAV, wherein the apparatus comprises at least one processor; and
a memory communicatively connected to the at least one processor, wherein
the memory stores instructions capable of being executed by the at least one processor, and the instructions are executed by the at least one processor, to enable the at least one processor to:
obtain a distance between the UAV and an electronic fence;
apply a virtual resistance force to the UAV when the distance is less than a preset distance threshold value; and
obtain a speed instruction according to the virtual resistance force, to adjust a flight speed of the UAV according to the speed instruction.

7. The apparatus according to claim 6, wherein the virtual resistance force is obtained by using a virtual impedance model.

8. The apparatus according to claim 6, wherein the processor is configured to:
perform vector composition on the virtual resistance force and a force applied to the UAV to obtain a resultant force;
obtain a desired acceleration of the UAV according to the resultant force; and
obtain the speed instruction according to the desired acceleration.

9. The apparatus according to claim 6, wherein the processor is configured to:
unload the virtual resistance force when the distance is greater than the preset distance threshold value.

10. The apparatus according to claim 7, wherein the virtual impedance model comprises at least any of a virtual spring, a virtual damping and a virtual mass.

11. A UAV, comprising: a vehicle body, an arm connected to the vehicle body, a power system disposed in the arm, and a flight controller disposed in the vehicle body, wherein the flight controller comprises:
at least one processor; and
a memory communicatively connected to the at least one processor, wherein
the memory stores instructions capable of being executed by the at least one processor, and the instructions are executed by the at least one processor, to enable the at least one processor to:
obtain a distance between the UAV and an electronic fence;
apply a virtual resistance force to the UAV when the distance is less than a preset distance threshold value; and
obtain a speed instruction according to the virtual resistance force, to adjust a flight speed of the UAV according to the speed instruction.

12. The UAV according to claim 11, wherein the virtual resistance force is obtained by using a virtual impedance model.

13. The UAV according to claim 11, wherein the processor is configured to:
perform vector composition on the virtual resistance force and a force applied to the UAV to obtain a resultant force;
obtain a desired acceleration of the UAV according to the resultant force; and
obtain the speed instruction according to the desired acceleration.

14. The UAV according to claim 11, wherein the processor is configured to:
unload the virtual resistance force when the distance is greater than the preset distance threshold value.

15. The UAV according to claim 12, wherein the virtual impedance model comprises at least any of a virtual spring, a virtual damping and a virtual mass.

16. A non-transitory computer readable memory medium storing program instructions executable by processing circuitry to cause a processor to:
obtain a distance between the UAV and an electronic fence;
apply a virtual resistance force to the UAV when the distance is less than a preset distance threshold value; and
obtain a speed instruction according to the virtual resistance force, to adjust a flight speed of the UAV according to the speed instruction.

17. The non-transitory memory medium according to claim 16, wherein the virtual resistance force is obtained by using a virtual impedance model.

18. The non-transitory memory medium according to claim 16, wherein the program instructions are further executable to:
perform vector composition on the virtual resistance force and a force applied to the UAV to obtain a resultant force;
obtain a desired acceleration of the UAV according to the resultant force; and
obtain the speed instruction according to the desired acceleration.

19. The non-transitory memory medium according to claim 16, wherein the program instructions are further executable to:
unload the virtual resistance force when the distance is greater than the preset distance threshold value.

20. The non-transitory memory medium according to claim 17, wherein the virtual impedance model comprises at least any of a virtual spring, a virtual damping and a virtual mass.
